(19) United States
(12) Patent Application Publication
(10) Pub. No.: US 2010/0133923 A1
(43) Pub. Date: Jun. 3, 2010

(54) FLAT SPRING PLATE FOR VOICE COIL MOTOR

(75) Inventors: Chia-Hung Liao, Tu-Cheng (TW); Chau-Yuan Ke, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/507,994

(22) Filed: Jul. 23, 2009

(30) Foreign Application Priority Data
Dec. 2, 2008 (CN) 200810305919.6

(51) Int. Cl. H02K 41/035

(52) U.S. Cl. 310/12.02; 310/12.16

(57) ABSTRACT

An exemplary flat spring plate for a voice coil motor includes a first plate body, a second plate body, and a disposal body. The disposal body includes a connecting member, and a handle extending from the connecting member. The connecting member is configured for connecting the first plate body to the second plate body. The handle is configured for facilitating removal of the connecting member from the first and second plate bodies.

### BACKGROUND

1. Technical Field

The present disclosure relates to a flat spring plate for a voice coil motor, and particularly to a flat spring plate for easy assembly.

2. Description of Related Art

A voice coil motor (VCM) has the advantages of small volume, low power consumption, accurately actuated displacement, and low cost. The voice coil motor is suitable for use as a short-distance actuator in many electronic products, such as vibrating motors for mobile phones, vertical displacement actuators for a magnetic head or an optical pickup, auto-focusing actuators for cameras, etc.

Generally, a voice coil motor used in an auto-focusing camera includes a fixed frame having a receiving cavity defined in the center thereof, a plurality of magnets arranged around the periphery of the fixed frame, a movable barrel for receiving lenses or filters therein, coils fixed on the outer wall of the movable barrel, and a flat spring plate arranged on one end of the movable barrel. The movable barrel is received in the receiving cavity of the fixed frame, and moves upwards and downwards relative to the fixed frame. The flat spring plate includes a first plate body and a second plate body separate from the first plate body. The first and second plate bodies are electrically connected to the two ends of the coils, respectively, for applying current to the coils. When the coils are applied with current, the coils produce a magnetic field, which attracts or repulses the magnetic field produced by the magnets, such that the movable barrel moves upwards or downwards.

However, because the first plate body is separate from the second plate body, in manufacturing process, the first and second plate bodies need to be separately manufactured, and in assembly process, the first and second plate bodies need to be fixed on the end of movable barrel, respectively. Therefore, the manufacturing and assembly processes of the flat spring plate are very complicated.

Therefore, what is needed is a flat spring plate easy to be manufactured and assembled.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a flat spring plate according to a first embodiment, the flat spring plate including two connecting bodies.

FIG. 2 is an enlarged view of the circled portion II of FIG. 1.

FIG. 3 is a schematic, isometric view of the flat spring plate of FIG. 1, a fixed unit, and a movable unit, showing the flat spring plate fixed with the fixed unit and the movable unit.

FIG. 4 is a schematic, isometric view of a voice coil motor, showing the flat spring plate in FIG. 3 being free of the two connecting bodies.

FIG. 5 is an exploded, isometric view of the voice coil motor of FIG. 4.

FIG. 6 is a schematic, isometric view of a flat spring plate according to a second embodiment.

FIG. 7 is a schematic, isometric view of a flat spring plate according to a third embodiment.

### DETAILED DESCRIPTION

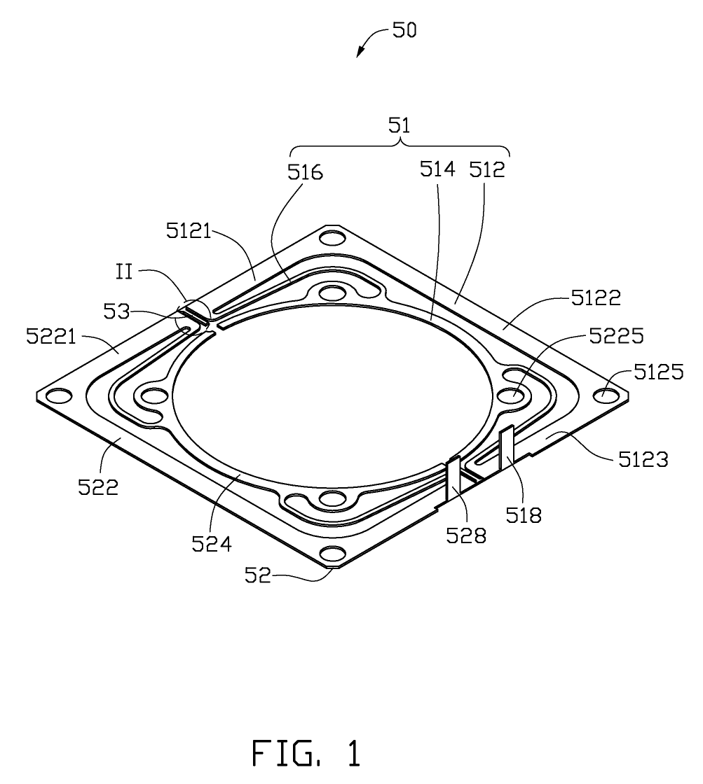

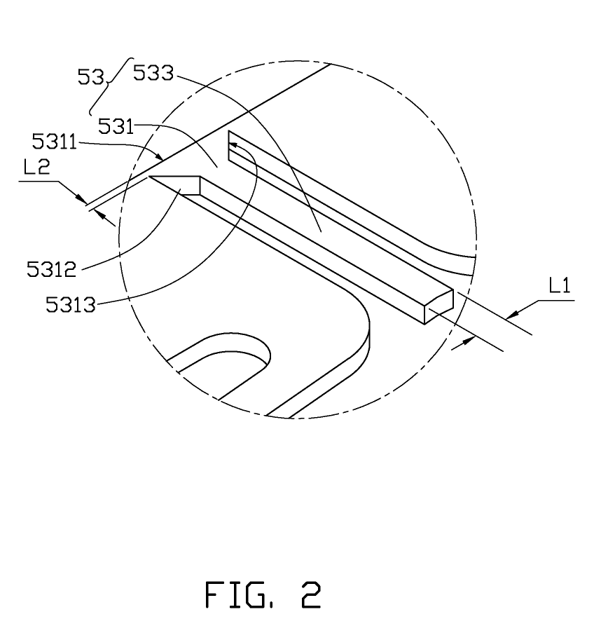

Referring to FIGS. 1-2, a flat spring plate 50, in accordance with a first embodiment, is shown. The flat spring plate 50 includes a first plate body 51, a second plate body 52, and two disposal bodies 53 for connecting the first plate body 51 to the second plate body 52.

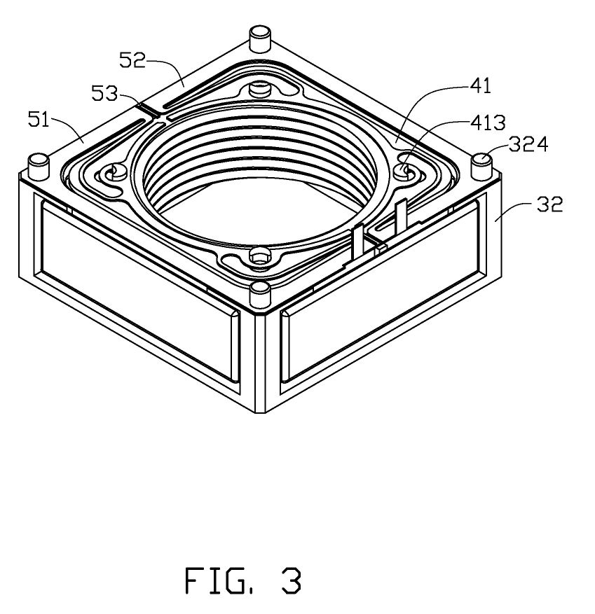

The first plate body 51 includes an outer frame 512, an inner frame 514, and two spring parts 516. The outer frame 512 is fixed to the top side of a cubic bracket 32 (see FIG. 3). The inner frame 522 is fixed to the top side of a movable barrel 41 (see FIG. 3). In the present embodiment, the outer frame 512 is U-shaped, and includes a first edge 5121, a second edge 5122 abutting against the first edge 5121, and a third edge 5123 abutting against the second edge 5122 and parallel with the first edge 5121. In other embodiment, the first plate body 51 may instead be arc-shaped. The outer frame 512 also includes two first locating holes 5125 defined thereon.

In the present embodiment, the inner frame 514 is arc-shaped, and each spring part 516 is L-shaped. One end of the spring part 516 is connected to the inner frame 514. Another end of the spring part 516 is connected to the outer frame 512. In this embodiment, the two connecting bodies 53 are integrally formed with the first and second plate bodies 51, 52. The first and second plate bodies 51, 52, and the two connecting bodies 53 cooperatively form a substantially square plate. In other embodiment, the first and second plate bodies 51, 52, and the two connecting bodies 53 may cooperatively form a substantially round plate.

For easy manufacturing, the structure of the second plate body 52 is identical to that of the first plate body 51. The second plate body 52 also includes an outer frame 522, and an inner frame 524. The outer frame 522 also includes a first edge 5221, and two second locating holes 5225 defined therein.

Each disposal body 53 includes a connecting member 531 and a handle 533 extending from the connecting member 531. The connecting member 531 connects the first plate body 51 to the second plate body 52. The handle 533 is separate from the first and second plate bodies 51, 52. The handle 533 is configured for facilitating removal of the connecting member 531 from the first and second plate bodies 51, 52. The shortest width of the handle 533 is L1. In the present embodiment, the first and second plate bodies 51, 52 are respectively located on the two sides of the connecting member 531, the connecting member 531 connects the outer frame 512 of the first plate body 51 to the outer frame 522 of the second plate body 52, and the inner frames 514,524 of the first and second plate bodies 51, 52 are separate from each other. In other embodiment, the connecting member 531 can instead connect the inner frame 514 of the first plate body 51 to the inner frame 524 of the second plate body 52, and the outer frames 512, 522 of the first and second plate bodies 51, 52 can instead be separate from each other.

The connecting member 531 includes an end surface 5311, two inclined surfaces 5312, 5313. The end surface 5311, and the two outer surfaces of the first edges 5121, 5221 lie in the same plane, and the end surface 5311 connects the outer surface of the first edge 5121 to the outer surface of the first edge 5221. The two inclined surfaces 5312, 5313 are respectively located on the two sides of the handle 533, and are respectively abutting against the handle 533. The brim of the inclined surface 5312 is abutting against the first plate body 51, and the inclined surface 5312 is separate form the end surface 5311. The brim of the inclined surface 5313 is abutting against the second plate body 52, and the inclined surface 5312 is separate form the end surface 5311. The shortest distance between the inclined surface 5313 and the end surface 5311 is L2. In the present embodiment, the shortest distance between the inclined surface 5313 and the end surface 5311 is L2, too, and the L2 is shorter than L1 for ensuring the bonding strength between the handle 533 and the connecting member 531 is larger than the bonding strength between the connecting member 531 and the outer frames 512, 522 of the first and second plate bodies 51, 52.

The first and second plate bodies 51, 52 also include a first and second terminals 518, 528, respectively connected to the outer frames 512, 522 of the first and second plate bodies 51, 52.

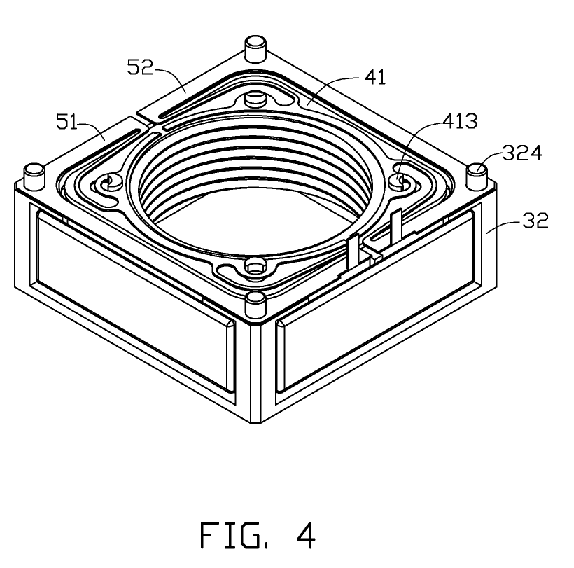

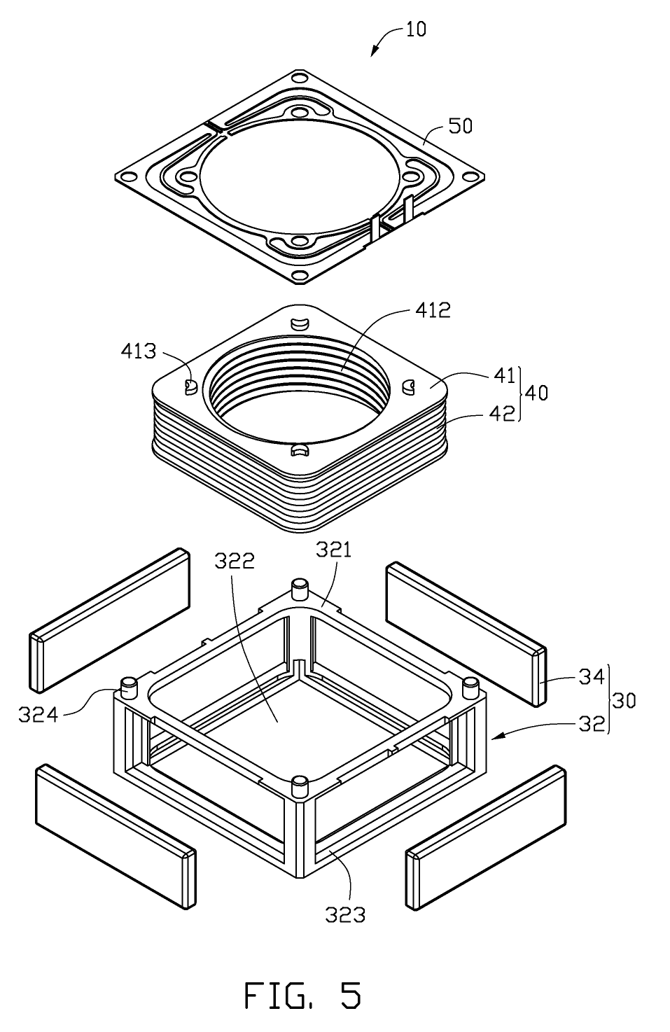

Referring also to FIGS. 4-5, a voice coil motor 10 is shown. The voice coil motor 10 includes a fixed unit 30, a movable unit 40, and the flat spring plate 50. The outer frames 512, 522 are fixed to the top side of the fixed unit 30. The inner frames 514, 524 are fixed to the top side of the movable unit 40.

The fixed unit 30 includes the cubic bracket 32 and a plurality of magnets 34. The bracket 32 includes a frame body 321. A first accommodation room 322 is defined in the frame body 321. Four magnet mounting holes 323 are respectively formed in four sides of the frame body 321. The magnet mounting holes 323 are in communication with the first accommodation room 322. Four first locating pins 324 are respectively vertically protruded from the top side of the frame body 321 at each corner thereof. The first locating pins 324 are configured for working with the first locating holes 5125 to locate and fasten the fixed unit 30 to the flat spring plate 50. The number of the magnets 34 corresponds to that of the magnet mounting holes 323. The magnets 34 are respectively mounted in the magnet mounting holes 323.

The movable unit 40 includes the movable barrel 41 and coils 42. The movable unit 40 is accommodated in the first accommodating room 322 of the bracket 32. The movable barrel 41 defines a second accommodating room 412 for accommodating the lenses and filters (not shown). The second accommodating room 412 is a through hole. Four second locating pins 413 are respectively vertically protruded from the top side of the movable barrel 41 at each corner thereof. The second locating pins 413 are configured for working with the second locating holes 5225 to locate and fasten the movable barrel 41 to the flat spring plate 50. The coils 42 are warped around the outer wall of the movable barrel 41.

In assembly process, first, the inner frames 514, 524 of the flat spring plate 50 are fixed to the top side of the movable barrel 41, and the two ends of the coils 42 are electrically coupled to the inner frames 514, 524, respectively. Then, the outer frames 512, 522 of the flat spring plate 50 are fixed to the top side of the frame body 21. Finally, each handle 533 is drawn in a direction towards a corresponding interconnected connecting member 531 until the disposal body 53 is totally torn off from the first and second plate bodies 51, 52. Accordingly, the first plate body 51 is separate from the second plate body 52.

Because the first and second bodies 51, 52 are assembled at the same time, the assembly process of the flat spring plate 50 is simple. Due to the handles 533, the process of removal of the connecting member 531 from the first and second plate bodies 51, 52 is simple. So, the assembly process of the voice coil motor 10 is simple.

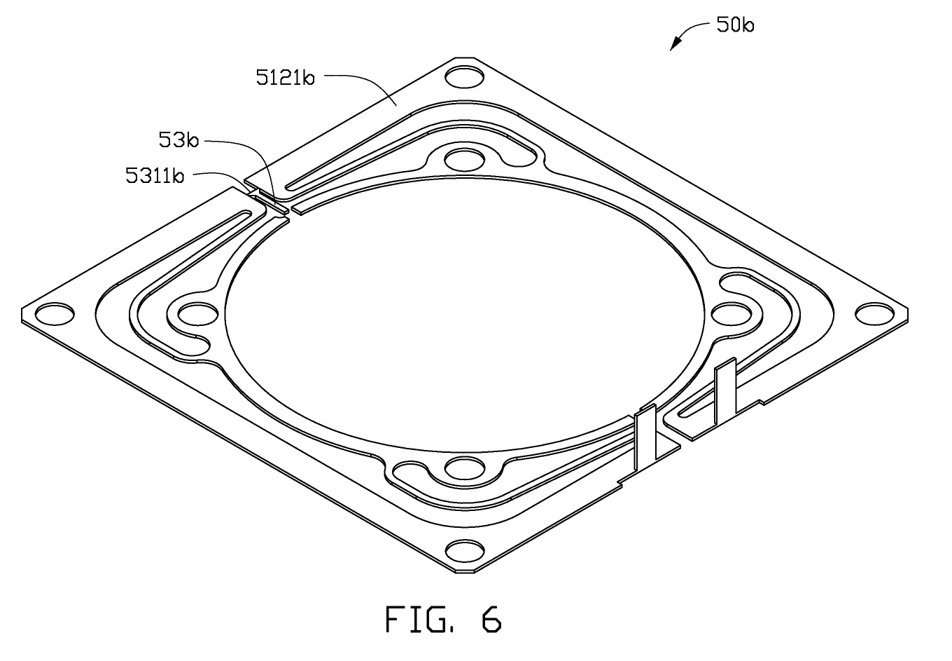

Referring to FIG. 6, a flat spring plate 50b, in accordance with a second embodiment, is shown. The flat spring plate 50b includes a first edge 5121b, and a connecting member 531b. The flat spring plate 50b is similar to the flat spring plate 50, except that the end surface 5311b of the connecting member 531b, and the outer surface of the first edge 5121b don't lie in the same plane.

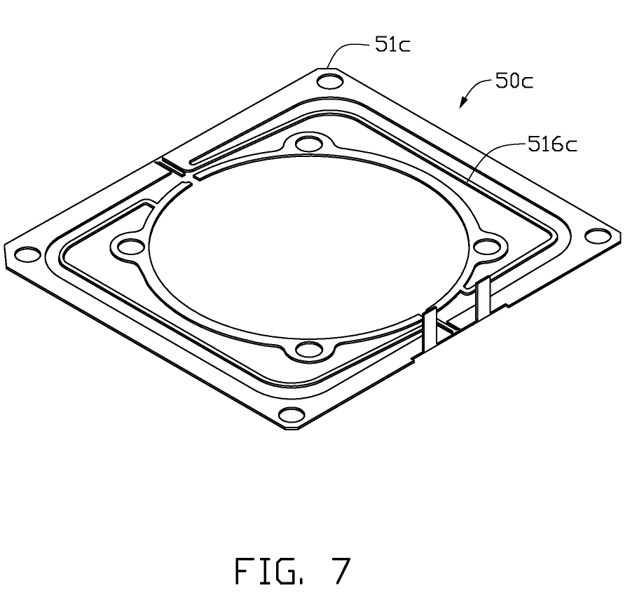

Referring to FIG. 7, a flat spring plate 50c, in accordance with a third embodiment, includes a first plate body 51c. The flat spring plate 50c is similar to the flat spring plate 50, except that the first plate body 51c includes a U-shaped spring part 516c.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope of the appended claims.

What is claimed is:

1. A flat spring plate for a voice coil motor, comprising:
a first plate body;
a second plate body; and
a disposal body, the disposal body comprising a connecting member, and a handle extending from the connecting member, the connecting member being configured for connecting the first plate body to the second plate body, the handle being configured for facilitating removal of the connecting member from the first and second plate bodies.

2. The flat spring plate of claim 1, wherein the first and second plate bodies each comprise an outer frame, the connecting member connects the outer frame of the first plate body to the outer frame of the second plate body, the first and second plate bodies are respectively located on the two sides of the connecting member.

3. The flat spring plate of claim 2, wherein the bonding strength between the handle and the connecting member is larger than the bonding strength between the connecting member and the outer frames of the first and second plate bodies.

4. The flat spring plate of claim 3, wherein the connecting member comprises an end surface, and an inclined surface, the shortest distance between the inclined surface and the end surface is shorter than the shortest width of the handle.

5. The flat spring plate of claim 1, wherein the first plate body further comprises an inner frame and a spring part, the spring part connects the inner frame of the first plate body to the outer frame of the first plate body.

6. The flat spring plate of claim 1, wherein the structure of the first plate body is identical to that of the second plate body.

7. The flat spring plate of claim 1, wherein the disposal body is integrally formed with the first and second plate bodies.

8. A flat spring plate for a voice coil motor, comprising:
a first plate body;
a second plate body; and
a disposal body, the disposal body comprising a connecting member, and a handle extending from the connecting member, the connecting member being configured for connecting the first plate body to the second plate body, the handle being configured for facilitating removal of the connecting member from the first and second plate bodies, the bonding strength between the handle and the connecting member being larger than the bonding strength between the connecting member and the outer frames of the first and second plate bodies.

9. The flat spring plate of claim 8, wherein the first plate body further comprises an inner frame and a spring part, the spring part connects the inner frame of the first plate body to the outer frame of the first plate body.

10. The flat spring plate of claim 8, wherein the structure of the first plate body is identical to that of the second plate body.

11. The flat spring plate of claim 8, wherein the disposal body is integrally formed with the first and second plate bodies.
